(19) United States
(12) Patent Application Publication
(10) Pub. No.: US 2020/0255289 A1
(43) Pub. Date: Aug. 13, 2020

(54) METHOD FOR STORING HYDROGEN

(71) Applicants: UNIVERSITE DE BORDEAUX, BORDEAUX (FR); INSTITUT POLYTECHNIQUE DE BORDEAUX, TALANCE (FR); CENTRE NATIONAL DE LA RECHERCHE SCIENTIFIQUE, PARIS-CEDEX (FR)

(72) Inventor: Mathieu Jonathan Damien PUCHEAULT, CAMBLANES ET MEYNAC (FR)

(21) Appl. No.: 16/647,033

(22) PCT Filed: Sep. 13, 2018
(86) PCT No.: PCT/FR2018/052250

§ 371 Date: Mar. 13, 2020

(30) Foreign Application Priority Data
Sep. 14, 2017 (FR) 1758543

(51) Int. Cl. C01B 3/00; C07F 5/02

(52) U.S. Cl. CPC C01B 3/0015; C07F 5/027

(57) ABSTRACT

Disclosed is the application of alkoxyamine-borane complexes for the storage of hydrogen.

### BACKGROUND OF THE INVENTION

### Field of the Invention

The present invention relates to a new method for storing hydrogen using alkoxyamine-borane complexes.

### Description of the Related Art

The alkoxyamine-borane complexes represented below comprise a dative bond between the nitrogen atom and BH₃, just as in amine-borane complexes.

These compounds are only described in two articles dating from 1958 (Parry et al. JACS 1958, 80, 1549;. Parry et al. JACS 1958, 80, 1868.).

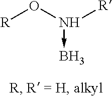

### General Structure of Alkoxyamine-Borane Complexes

The synthesis of these compounds being described with toxic compounds and which are no longer used such as diborane gas, it was necessary to develop a slightly- or non-toxic, economical synthesis that allows for easy scale-up.

Current solutions for storing hydrogen are split into two main categories: physical storage and storage in the form of materials.

The physical storage is currently the most advanced technology and consists of a liquid hydrogen tank operating between 350 and 700 bar, with operating temperatures the order of −120° C.

The storage in the form of materials can be divided into three distinct classes: absorbent materials (zeolites, aerogels, . . . ), metal hydrides (LiAlH₄, NaBH₄, MgH₂, . . . ) and chemical storage, in particular in the form of conventional amine-borane complexes (NH₃BH₃, MeNH₂BH₃, Me₂NHBH₃, . . . )

However, the solutions mentioned above have drawbacks: the drastic conditions of temperature and pressure for the physical storage, the cost and the fouling of the materials for the absorbent materials, the need to use reagents under stoichiometric conditions in order to have a reversible dehydrogenation of the metal hydrides, and finally a complicated rehydrogenation of conventional amine-borane complexes.

The transformation of alkoxyamine-borane complexes into the corresponding aminoboranes and iminoboranes by catalytic dehydrogenation has never been described.

### SUMMARY OF THE INVENTION

One of the most general aspects of the invention concerns a new simple method for storage and release of hydrogen, not involving toxic compounds, and allowing for high storage levels of hydrogen due to the low molecular weight of the alkoxyamine-borane complexes.

According to one of the most general aspects, the invention relates to the use of alkoxyamine-borane complexes for storing hydrogen.

Within the meaning of the invention, it is understood by “alkoxyamine-borane complex”, complex formed by reaction between an alkoxyamine and a borane.

By “storing hydrogen”, it is understood, within the meaning of the invention, a method allowing to conserve hydrogen and then release it in view of its use.

The present invention also relates to the use of alkoxyamine-borane complexes for storing hydrogen followed by a step of release of hydrogen.

Within the meaning of the invention, it is understood by “release of hydrogen”, the chemical step to allow to obtain a release of hydrogen.

The invention enables to have a very promising hydrogen chemical tank. Thus, these compounds present a hydrogen availability of in particular 6.67% by mass, which is as good as, or better than, all other types of storage.

The present invention also relates to the use of alkoxyamine-borane complexes for stoning hydrogen, said complexes being alkoxyamine-boranes of formula (I),

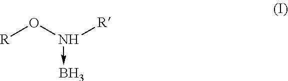

wherein R and R′ are independently selected from hydrogen, C₁ to C₁₀-alkyl or C₃ to C₁₀-cycloalkyl group.

Within the meaning of the invention, the term “C₁ to C₁₀-alkyl” refers to an acyclic saturated carbon chain, linear or branched, comprising 1 to 10 carbon atoms. Examples of C₁ to C₁₀-alkyl include methyl-, ethyl-, propyl-, butyl-, pentyl-, hexyl- or heptyl groups. The definition of propyl, butyl, pentyl, hexyl or heptyl includes all possible isomers. For example, the term butyl includes n-butyl, iso-butyl, sec-butyl and tea-butyl and the term propyl comprises n-propyl and iso-propyl.

Within the meaning of the present invention, the term “C₃ to C₁₀-cycloalkyl” refers to a saturated or partially saturated mono-, bi- or tri-cycle, comprising from 3 to 10 carbon atoms. For example, the cycloalkyl. group may be a cyclohexyl group.

The present invention also relates to a method for releasing hydrogen from alkoxyamine-borane complexes comprising a step of dehydrogenation of said alkoxyamine-borane complexes.

The present invention also relates to a method for releasing hydrogen from alkoxyamine-borane complexes, comprising a step of contacting of at least one alkoxyamine-borane complex with a catalyst or a step of thermal heating of the abovementioned alkoxyamine-borane complexes.

According to an advantageous embodiment, the invention relates to a method for releasing hydrogen from alkoxyamine-borane complexes comprising a step of dehydrogenation of said alkoxyamine-borane complexes, and a step of contacting at least one alkoxyamine-borane complex with a rhodium, platinum, palladium, gold or nickel complex, in particular chosen from RhCl (PPh₃)₃, NiCl₂(PPh₃)₂, Rh@TBAB and Ni@TBAB, Pd(OH)₂/C, PtCl₂, PdCl₂, KAuCl₄, Pt(PPh₃)₄.

The present invention also relates to a method for releasing hydrogen from alkoxyamine-borane complexes comprising a step of dehydrogenation of said alkoxyamine-borane complexes, and a step of contacting of an alkoxyamine-borane complex with RhCl(PPh₃)₃.

The present invention also relates to a method for releasing hydrogen from alkoxyamine-borane complexes comprising a step of dehydrogenation of said alkoxyamine-borane complexes, and a step of contacting of an alkoxyamine-borane complex with NiCl₂(PPh₃)₂.

The present invention also relates to a method for releasing hydrogen from alkoxyamine-borane complexes comprising a step of dehydrogenation of said alkoxyamine-borane complexes, and a step of contacting of an alkoxyamine-borane complex with Rh@TBAB.

The present invention also relates to a method for releasing hydrogen from alkoxyamine-borane complexes comprising a step of dehydrogenation of said alkoxyamine-borane complexes, and a step of contacting of an alkoxyamine-borane complex with Ni@TBAB.

The hydrogen release reaction is generally carried out in the presence of a catalyst derived from a metal selected from rhodium, nickel, palladium, platinum, copper, at a temperature ranging from 30° C. to 80° C., for a period ranging from 3 to 1500 minutes. The hydrogen release reaction starting from 0.5 mmol of one of the above-mentioned alkoxyamine-borane complexes can produce 5 cm³ to 25 cm³ of gas.

According to another advantageous embodiment, the invention relates to a method for releasing hydrogen from alkoxyamine-borane complexes comprising a step of dehydrogenation of said alkoxyamine-borane complexes by thermal heating of the above-mentioned alkoxyamine-borane complexes above 80° C., preferably above 100° C. and more preferably above 120° C.

According to a particular embodiment of the invention, the following five alkoxyamine-borane complexes are synthesized and used in the invention.

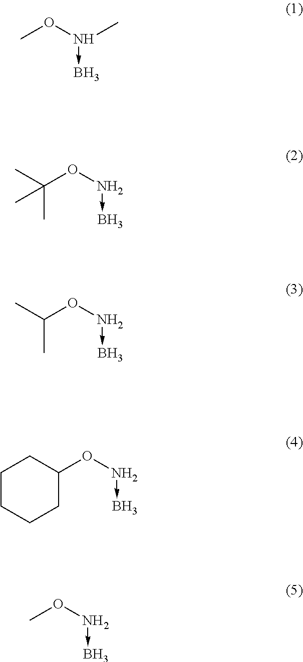

The present invention also relates to a method for preparing alkoxyamine-borane complexes of formula (I) comprising a step of bringing together hydroxylamines of formula (II),

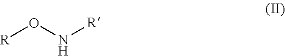

wherein R and R′ are selected from hydrogen, a C₁ to C₁₀-alkyl or C₃ to C₁₀-cycloalkyl group, or a salt thereof, for example a hydrochloride,

and NaBH₄ and a mineral acid, preferably H₂SO₄ or HCl, this method not requiring a purification step.

Within the meaning of the invention, it is understood by “mineral acid”, an acid derived from a mineral or inorganic body, for example hydrochloric, sulfuric or nitric acid,

The preparation of the alkoxyamine-borane complexes of formula (I) is generally carried out in an organic solvent, preferably THF (tetrahydrofuran).

According to an advantageous embodiment, the invention relates to a method for preparing the following alkoxyamine-borane complexes:

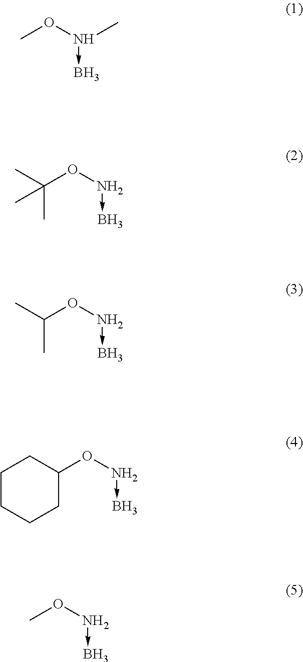

comprising a step of bringing together respectively the following hydroxylamine hydrochlorides:

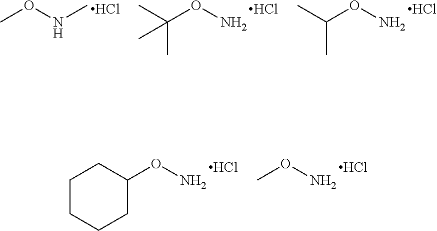

and NaBH₄ and a mineral acid, preferably H₂SO₄ or HCl, this method not requiring a purification step.

The preparation of the alkoxyamine-borane complexes of formula (I) is generally carried out with a ratio of hydroxylamine hydrochloride/NaBH₄ from 1:1 to 1:2, this ratio being, according to a preferred embodiment of the invention, fixed at 1:1.2.

### BRIEF DESCRIPTION OF THE DRAWINGS

FIG. 1 relates to the study of the rate of dehydrogenation of complex (5) in the presence of 5 mol % of Wilkinson catalyst with on the x-axis the time expressed in minutes and on the y-axis the evolution of the gas volume expressed in cm³.

FIG. 2 relates to the study of the rate of dehydrogenation of complex (2) in the presence of 5 mol % of Wilkinson's catalyst with on the x-axis the time expressed in minutes and on the y-axis the evolution of the gas volume expressed in cm³.

FIG. 3 relates to the study of the rate of dehydrogenation of complex (5) in the presence of 5 mol % of NiCl₂(PPh₃)₂ with on the x-axis the time expressed in minutes and on the y-axis the evolution of the gas volume expressed in cm³.

FIG. 4 relates to the study of the rate of dehydrogenation of complex (5) in the presence of 5 mol % of Pt(PPh₃)₄ with on the x-axis the time expressed in minutes and on the y-axis the evolution of the gas volume expressed in cm³.

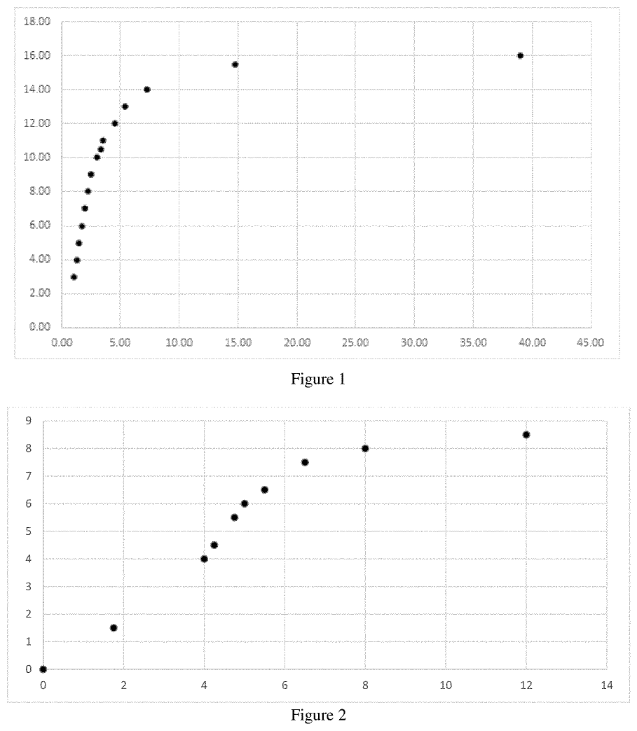

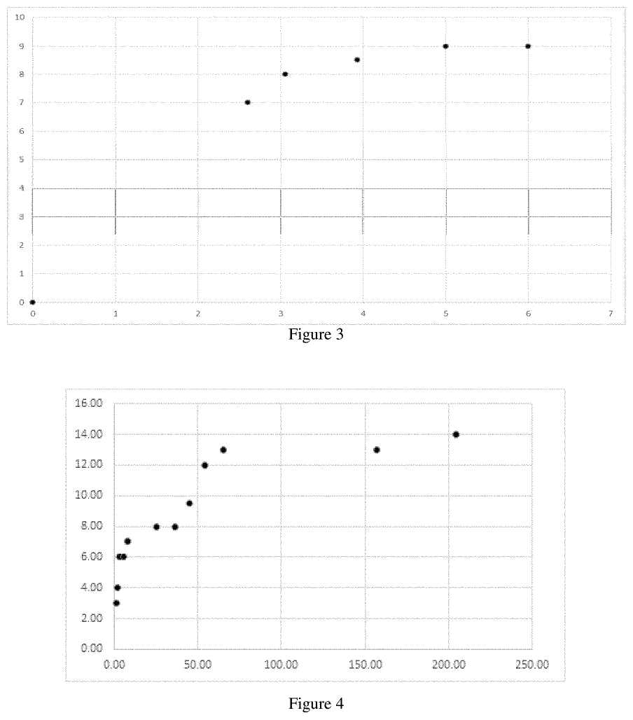

### DESCRIPTION OF THE PREFERRED EMBODIMENTS

### Examples Relating to the Preparation of Alkoxyamine-Borane Complexes

### Example 1

Tests carried out by the inventors to synthesize an alkoxyamine-borane complex from N,O-dimethylhydroxyhamine in the presence only of NaBH₄ in THF resulted in a good yield of 77% in 2 hours.

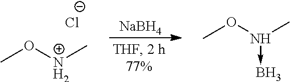

Optimization work on this synthesis (Table I) provided access to a yield of 86%. The results show that the optimum ratio between the alkoxyamine·HCl and NaBH₄ is 1:1.2. The obtained complex does not require purification.

TABLE 1

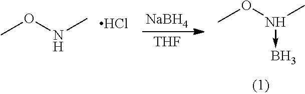

| | NaBH₄ | Temperature | Time | | |
|---|---|---|---|---|---|
| Reference | (eq.) | (° C.) | (h) | Treatment | Yield (%) |
| CF32dry | 2 | 70 | 72 | NaHCO₃/DCM | 6.5 |
| CF35 | 2 | RT | 48 | NaHCO₃/DCM | 76 |
| CF65 | 1.6 | RT | 24 | NaHCO₃/DCM | 64 |
| CF651 | 1.2 | 70 | 24 | NaHCO₃/DCM | 86 |
| CF673 | 1.2 | 70 | 24 | NaHCO₃/DCM | 63 |
| CF652 | 1.2 | RT | 24 | NaHCO₃/DCM | 51 |
| CF653 | 2 | RT | 24 | NaHCO₃/DCM | 79 |
| CF6541 | 1.2 | RT | 2 | NaHCO₃/DCM | 68 |
| CF6542 | 1.2 | RT | 2 | H₂O/EtOAc | 77 |

### Example 2

The alkoxyamine-borane complex (2) was synthesized under the same conditions as above, using O-tert-butylhydroxylamine hydrochloride in the presence of sodium borohydride in THE (Table 2). This synthesis was first performed on a small scale (CF39) and then on a larger scale (CF452).

TABLE 2

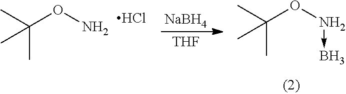

| | NaBH₄ | Temperature | Time | | |
|---|---|---|---|---|---|
| Reference | (eq.) | (° C.) | (h) | Treatment | Yield (%) |
| CF39 | 2 | RT | 24 | NaHCO₃/DCM | 38 |
| CF452 | 2 | RT | 24 | NaHCO₃/DCM | 64 |
| CF522 | 1.3 | RT | 24 | NaHCO₃/DCM | 48 |

### Examples 3 and 4

Unlike previous syntheses, the alkoxyamine-borane complexes (3) and (4) were prepared from non-commercial hydrochlorides (Tables 3, 4 and 5) which therefore had to be synthesized beforehand.

TABLE 3

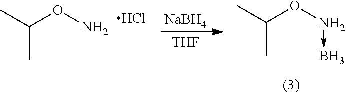

| | | Temperature | Time | | |
|---|---|---|---|---|---|
| Reference | NaBH₄ (eq.) | (° C.) | (h) | Treatment | Yield (%) |
| CF77 | 1.2 | RT | 24 | H₂O/Et₂O | 37.6 |
| CF80 | 1.2 | RT | 24 | H₂O/Et₂O | 35 |

TABLE 4

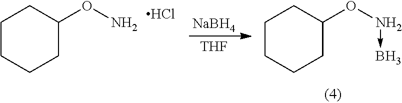

| | | Temperature | Time | | |
|---|---|---|---|---|---|
| Reference | NaBH₄ (eq.) | (° C.) | (h) | Treatment | Yield (%) |
| CF89 | 1.2 | RT | 24 | H₂O/Et₂O | 65 |
| CF97 | 1.2 | RT | 24 | H₂O/Et₂O | 18 |

### Example 5

The last alkoxyamine-borane complex that was synthesized is O-methylhydroxylamine-borane (5) from the commercial O-methylhydroxylamine hydrochloride in the presence of NaBH₄ in THE. Unlike the other starting materials, this hydrochloride has low solubility in most solvents. For this synthesis, significant work on optimizing the conditions has been performed in order to improve the solubility of O-methylhydroxylamine hydrochloride (Table 5).

TABLE 5

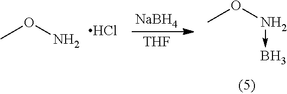

| | NaBH₄ | Temperature | Time | | Yield | Comments/ |
|---|---|---|---|---|---|---|
| Reference | (eq.) | (° C.) | (h) | Treatment | (%) | Modifications |
| CF44 | 2 | RT | 24 | NaHCO₃/DCM | 21 | |
| CF462 | 2 | RT | 24 | NaHCO₃/DCM | 10 | |
| CF53 | 1.25 | RT | 24 | NaHCO₃/DCM | 17 | |
| CF571 | 1.2 | 70 | 24 | NaHCO₃/DCM | 18 | |
| CF645 | 1.2 | 70 | 24 | NaHCO₃/DCM | 7 | Sonication 1 h |
| CF648 | 1.2 | RT | 24 | H₂O/Et₂O | 47 | Dehydrogenation (20 ml |
| | | | | | | of gas formed) |
| CF64EtA | 1.2 | RT | 24 | H₂O/Et₂O | 12 | Solvent: THF/EtOAc |
| CF64EtA2 | 2 | RT | 24 | H₂O/Et₂O | 28 | Solvent: |
| | | | | | | THF/EtOAc/EtOH |
| CF64De2 | 1.2 | 30 | 24 | H₂O/Et₂O | 43 | Dehydrogenation (15 ml |
| | | | | | | of 40 mL of expected |
| | | | | | | gas) |
| CF641eq | 1 | 30 | 24 | H₂O/Et₂O | 44 | |
| CF642eq | 2 | 30 | 24 | H₂O/Et₂O | 246 | Difficulties in drying the |
| | | | | | | product |
| CF64H2O | 1.2 | 30 | 24 | H₂O/Et₂O | 64 | Solvent: THF/H₂O |
| CF64H2O1 | 1.2 | 30 | 24 | H₂O/Et₂O | 53 | Excess THF |
| CF64H2O2 | 1.2 | 30 | 24 | H₂O/Et₂O | 46 | Less THF |
| CF64H2O3 | 1.2 | 30 | 24 | H₂O/Et₂O | 17 | Fast addition of a |
| | | | | | | MeONH₃⁺Cl⁻/H₂O |
| | | | | | | solution |
| CF64H2O4 | 1.2 | 30 | 24 | H₂O/Et₂O | 14 | Dropwise addition of a |
| | | | | | | MeONH₃⁺Cl⁻/H₂O |
| | | | | | | solution |
| CF64H2O5 | 1.2 | 30 | 72 | H₂O/Et₂O | 20 | NaBH₄ added last |
| CF64H2O6 | 1.2 | 30 | 24 | H₂O/Et₂O | 26 | NaBH₄ added last |
| CF64H2O7 | 1.2 | 30 | 24 | H₂O/Et₂O | 44 | Saturated solution of |
| | | | | | | MeONH₃⁺Cl⁻/H₂O |
| CF64H2O8 | 1.2 | 30 | 24 | H₂O/Et₂O | 39 | Diluted solution of |
| | | | | | | MeONH₃⁺Cl⁻/H₂O |

Examples related to the dehydrogenation of alkoxyamine-borane complexes:

Much research has been conducted on the alkoxyamine-borane complexes (1), (2) and (5). These experiments allowed to identify the interesting properties of the boron-nitrogen dative bond. The goal of these experiments was thus to establish the usefulness of these compounds as precursors in some reactions, for example in the formation of aminoboranes by dehydrogenation.

In addition, the alkoxyamin -borate complexes show strong potential for hydrogen storage applications because of their high density of hydrogen.

The dehydrogenation of the above-mentioned alkoxyamine-borane complexes in the presence of transition metal catalysts is described herein.

### Example 6

The most effective catalysts have been found to be Wilkinson's catalyst (RhCl(PPh₃)₃) and NiCl₂(PPh₃)₂ with which one equivalent of hydrogen was released from each alkoxyamine-borane complex (Tables 6, 7 and 8).

TABLE 6

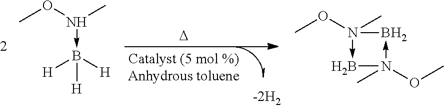

| | | Time | |
|---|---|---|---|
| Catalyst | Temperature (° C.) | (min) | Volume of formed gas (cm³) |
| PdCl₂dppp | 70 | 40 | 20 |
| Pd(OAc)₂ | 70 | 85 | 36 |
| Pd(OH)₂/C | 70 | 540 | 1.5 |
| NiCl₂•6H₂O | 70 | 1440 | 6 |
| RuCl₂•xH₂O | 30 | — | — |
| PtCl₂ | 30-50 | 900 | 20 |
| RhCl(PPh₃)₃ | 30 | 7 | 22 |
| NiCl₂(PPh₃)₃ | 30 | 29 | 22 |
| PdCl₂ | 30 | 47 | 22 |
| CuI | 30 | — | — |
| K(AuCl₄) | 30 | 69 | 8 |
| Pt(PPh₃)₄ | 30-70 | 204 | 14 |

### Examples 7 and 8

TABLE 7

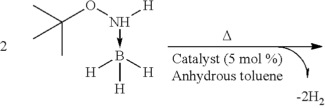

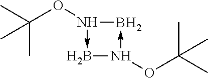

| | | Time | |
|---|---|---|---|
| Catalyst | Temperature (° C.) | (min) | Volume of formed gas (cm³) |
| Pd(OAc)₂ | 30-70 | — | — |
| Pd(OH)₂/C | 30-70 | 900 | 5.5 |
| PtCl₂ | 30-70 | 900 | 8 |
| RhCl(PPh₃)₃ | 30 | 12 | 8.5 |
| NiCl₂(PPh₃)₃ | 40 | 11.20 | 10 |
| PdCl₂ | 70 | 47.50 | 22 |

TABLE 8

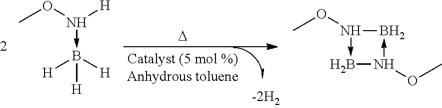

| | Temperature | Time | Volume of |
|---|---|---|---|
| Catalyst | (° C.) | (min) | formed gas (cm³) |
| Pd(OAc)₂ | 50-80 | 900 | 9 |
| Pd(OH)₂/C | 60-80 | 1050 | 8 |
| PtCl₂ (in THF) | 50 | 900 | 10 |
| RhCl(PPh₃)₃ (2.5 mol %) | 50 | 15 | 10 |
| NiCl₂(PPh₃)₃ | 30-50 | 36 | 12 |

The comparison of the decomposition rates of the three alkoxyamine-borane complexes (1), (2) and (5) clearly shows that the N,O-dimethylhydroxylarnine-borane (1) is the least stable of the three.

The complexes (1), (2) and (5) have different dehydrogenation speeds, the use of either of these complexes thus makes it possible to modulate the speed of dehydrogenation.

### Example 9

Additional tests were carried out on the O-methylhydroxylamine-borane complex (5) with Wilkinson's catalyst (RhCl(PPh₃)₃), NiCl₂(PPh₃)₂ and the corresponding nanocatalysts at 50° C. (Table 9).

The two nanocatalysts have emerged as effective in the dehydrogenation reaction of O-methylhydroxylamine-borane (5).

TABLE 9

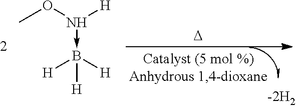

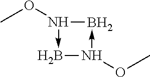

| | Temperature | | Volume of |
|---|---|---|---|
| Catalyst | (° C.) | Time (min) | formed gas (cm³) |
| RhCl(PPh₃)₃ | 50-80 | 3 | 10 |
| NiCl₂(PPh₃)₃ | 60-80 | 6 | 9 |
| Rh@TBAB | 50 | 37 | 15 |
| Ni@TBAB | 50 | 900 | 11 |
| RhCl(PPh₃)₃ | 60 | 108 | 15.5 |
| (additional 1 mol %) | | | |

1-13. (canceled)

14. A method for storing hydrogen, comprising providing and applying an effective amount of alkoxyamine-borane complexes.

15. The method according to claim 14, wherein the application of alkoxyamine-borane complexes for storing hydrogen is followed by a step of release of hydrogen.

16. The method according to claim 14, wherein the alkoxyamine-borane complexes are alkoxyamine-boranes of formula (I), 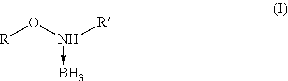
wherein R and R′ are independently selected from hydrogen, C₁ to C₁₀-alkyl or C₃ to C₁₀-cycloalkyl group.

17. A method for releasing hydrogen from alkoxyamine-borane complexes comprising a step of dehydrogenation of said alkoxyamine-borane complexes.

18. The method for releasing hydrogen according to claim 17, comprising a step of contacting of at least one alkoxyamine-borane complex with a catalyst, or step of thermal heating of the abovementioned alkoxyamine-borane complexes.

9. The method for releasing hydrogen according to claim 7, comprising a step of contacting at least one alkoxyamine-borane complex with a rhodium, platinum, palladium, gold or nickel complex.

20. The method for releasing hydrogen according to claim 17, comprising a step of contacting at least one alkoxyamine-borane complex with a complex chosen from RhCl(PPh₃)₃, NiCl₂(PPh₃)₂, Rh@TBAB and Ni@TBAB, Pd(OH)₂/C, PtCl₂, PdCl₂, KAuCl₄, Pt(PPh₃)₄.

21. The method for releasing hydrogen according to claim 17, comprising a step of contacting of an alkoxyamine-borane complex with RhCl (PPh₃)₃.

22. The method for releasing hydrogen according to claim 17, comprising a step of contacting of an alkoxyamine-borane complex with NiCl₂(PPh₃)₂.

23. The method for releasing hydrogen according to claim 17, comprising a step of contacting of an alkoxyamine-borane complex with Rh@TBAB.

24. The method for releasing hydrogen according to claim 17, comprising a step of contacting of an alkoxyamine-borane complex with Ni@TBAB.

25. The method for releasing hydrogen according to claim 17, comprising a step of thermal heating of the above-mentioned alkoxyamine-borane complexes above 80° C.

26. The method for releasing hydrogen according to claim 17, comprising a step of thermal heating of the above-mentioned alkoxyamine-borane complexes above 120° C.

27. A method for preparing alkoxyamine-borane complexes of formula (I) comprising a step of bringing together hydroxylamines of formula (II), 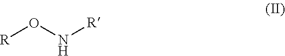
wherein R and R′ are selected from hydrogen, a C₁ to C₁₀-alkyl or C₃ to C₁₀-cycloalkyl group, or a salt thereof, with NaBH₄ and a mineral acid, said method not requiring a purification step.

28. The method for preparing alkoxyamine-borane complexes according to claim 27, wherein the salt is a hydrochloride salt.

29. The method for preparing alkoxyamine-borane complexes according to claim 27, wherein the mineral acid is H₂SO₄ or HCl.

30. The method of preparation according to claim 27, of the following alkoxyamine-borane complexes: 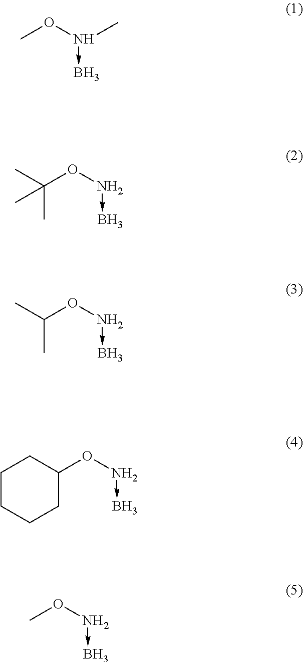
comprising a step of bringing together respectively the following hydroxylamine hydrochlorides: 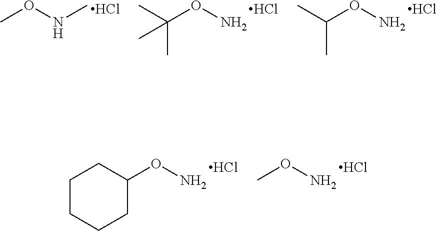
and NaBH₄ and a mineral acid, this method does not require purification step.

31. The method of preparation according to claim 27, of the following alkoxyamine-borane complexes: 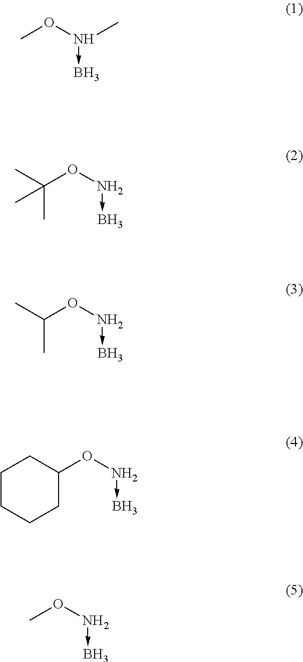
comprising a step of bringing together respectively the following hydroxylamine hydrochlorides: 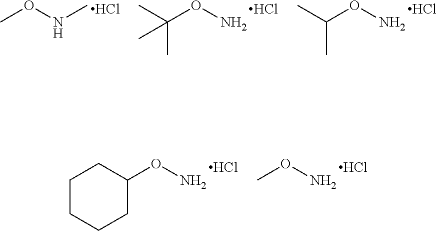
and NaBH₄ and a mineral acid chosen from H₇SO₄ or HCl, said method not requiring a purification step.
